(19) United States
(12) Patent Application Publication
(10) Pub. No.: US 2010/0224284 A1
(43) Pub. Date: Sep. 9, 2010

(54) REDUCING AGENT TANK

(75) Inventors: Ralf Kolberg, Bruhl (DE); Ibrahim Koukan, Koln (DE); Volker Treudt, Windeck (DE)

Correspondence Address: GROSSMAN, TUCKER, PERREAULT & PFLEGER, PLLC, 55 SOUTH COMMERICAL STREET, MANCHESTER, NH, 03101, US

(73) Assignee: KAUTEX TEXTRON GMBH & CO. KG, Bonn (DE)

(21) Appl. No.: 12/718,313

(22) Filed: Mar. 5, 2010

(30) Foreign Application Priority Data
Mar. 6, 2009 (DE) 10 2009 011 518.8

(51) Int. Cl. B65B 3/18; B60K 15/035; B65D 88/54

(52) U.S. Cl. 141/325; 220/86.2; 141/326

(57) ABSTRACT

The invention relates to a reducing agent tank (1) for motor vehicles, having at least one filler pipe (3) which is provided with a filler opening (4), having at least one device for filling deaeration and having means for limiting the fill level during filling, with the device for filling deaeration comprising at least one filling deaeration line (7) which extends at least in sections above the maximum fill level in the filler pipe (3) and/or in the tank (FIG. 2).

The invention relates to a reducing agent tank for motor vehicles.

In automotive technology, use is frequently made of the so-called SCR process in order to reduce pollutant emissions in diesel vehicles, primarily in utility vehicles. SCR refers to so-called Selective Catalytic Reduction in which nitrogen oxides are reduced by means of ammonia. Here, the required ammonia is for example injected in the form of an aqueous urea solution into the exhaust section upstream of the SCR catalytic converter. Ammonia and carbon dioxide are formed from the urea-water solution by means of a hydrolysis reaction. The ammonia can react, in a catalytic converter at a corresponding temperature, with the nitrogen oxides in the exhaust gas.

For this purpose, it is necessary to provide a reducing agent tank in the vehicle in question for the urea which is present in aqueous solution. The urea then releases ammonia, which can lead to the emission of an unpleasant odour. The drying-out of the solution is associated with intense crystal growth and an increase in volume. Therefore, reducing agent tanks carried in the motor vehicle must be prevented from drying out. Furthermore, clean replenishment or filling must be ensured.

In contrast to liquid hydrocarbons or fuels, aqueous urea solutions are at risk from frost, such that it must either be ensured that the reducing agent does not freeze or the tanks provided for this purpose must be designed such that a corresponding increase in volume of the urea, in particular when the vehicle is at a standstill, can be compensated.

Furthermore, as is the case with any operating fluid tank, it is necessary to ensure corresponding aeration and deaeration of the tank, in particular a deaeration of the tank during filling. It is fundamentally conceivable and possible to deaerate reducing agent tanks via filling openings which must inevitably be provided thereon. In the case of tanks provided on the outside of a motor vehicle, such as is the case for example in a utility vehicle, this causes virtually no problems. Only the odour nuisance during filling is less desirable. When using reducing agent tanks in a passenger motor vehicle, however, this is more of a problem. In the case of the passenger motor vehicle, the reducing agent tank is generally filled/refilled during a workshop visit at the regular servicing intervals. Since servicing intervals can nowadays be comparatively long, the reducing agent in the passenger motor vehicle has a longer residence time in the reducing agent tank than would be the case in a utility vehicle. This generally results in higher ammonia concentrations, and under some circumstances this can result in an increased odour nuisance.

Furthermore, when filling of reducing agent tanks, it is desirable not to exceed a certain fill quantity in particular on account of the volume increase when liquid urea freezes.

The invention is therefore based on the object of creating a reducing agent tank for motor vehicles which is designed so as to enable simple and clean filling, wherein over-replenishment of the reducing agent tank should be prevented both for reasons of hygiene and also for the purpose of frost protection.

The object is achieved by means of a reducing agent tank for motor vehicles, having at least one filler pipe which is provided with a filler opening, having at least one device for filling deaeration and having means for limiting the fill level during filling, with the device for filling deaeration comprising at least one filling deaeration line which extends at least in sections above the maximum fill level in the filler pipe and/or in the tank.

The design of the reducing agent tank according to the invention has the advantage that different paths are provided in each case for the filling and the deaeration and that a filling deaeration line which is connected in the manner according to the invention to the reducing agent tank can be open, and virtually unpressurized, during the filling of the reducing agent tank. This also has in particular the advantage that the filling deaeration line can be closed off at its end remote from the reducing agent tank. In this way, it is possible to avoid providing moving parts, such as for example valves, in the reducing agent tank. This makes allowance in particular for the fact that urea entering into the filling deaeration line can crystallize and possibly block the filling deaeration line or clog up moving parts provided there in the region of the tank connection.

It is expediently provided that the filling deaeration line forms a deaeration path which is at least substantially separate from the filling duct formed by the filler neck. In this way, it is possible to obtain gurgle-free and splash-free filling without a back surge.

In one variant of the reducing agent tank according to the invention, it may be provided that the filling deaeration line can be closed off in a fill-level-actuated manner. This may self-evidently take place by means of corresponding switching members actuated by the liquid level.

A variant is however particularly preferable in which the filling deaeration line is guided with a projection, which is designed as an immersion pipe, in the region of the maximum fill level in the interior of the tank, such that when the maximum admissible fill level is reached, said filling deaeration line is closed off by the liquid level. This causes a rise in the liquid column in the filler pipe if appropriate during a further filling of the reducing agent tank. This may lead either to the deactivation of a nozzle or to the closure of a filling container. If filling is carried out for example from a container such as a bottle or the like, the rising liquid column in the filler pipe closes off the opening of the container and prevents the latter from being aerated and therefore from being emptied further.

It is particularly advantageous if the reducing agent tank according to the invention has no movable fittings.

The reducing agent tank according to the invention expediently has provided on it at least one valve which closes off the filling deaeration line with respect to the atmosphere and which is preferably arranged at a distance from the tank connection of the filling deaeration line. A valve of said type reliably prevents the aqueous solution, which must be provided in the reducing agent tank, from drying out.

The valve may for example be held in spring-loaded fashion in the position in which the filling deaeration line is closed off. This may be physically realized for example by means of a spring element. Alternatively, a valve of said type may for example be designed as a so-called mushroom valve which is held in the closed position on account of the elastically resilient properties of the valve body itself.

Alternatively, the valve may be designed to be mechanically actuable.

In one advantageous variant of the reducing agent tank according to the invention, the valve can be actuated by means of a closure cover of the filler pipe. For example, the filling deaeration line may for this purpose be guided via a so-called filler head. Here, it is advantageously possible for a fastening point of the filling deaeration line to be provided in the region of the opening of the filler pipe or in the region of the closure cover fastening of the filler pipe.

It may alternatively be provided that the valve can be actuated by means of a Bowden cable.

It is particularly expedient if the valve is designed as a switching valve which, in the position in which the filling deaeration line is closed off, opens up a withdrawal aeration line and/or operational deaeration line.

The reducing agent tank according to the invention may be formed from a thermoplastic for example as an extrusion blow-moulded tank. Said tank may be produced such that at least the filler pipe and parts of the filling deaeration means are integrally formed on the tank. The reducing agent tank according to the invention may be formed, in single-layer or multi-layer design, from a thermoplastic by extrusion blow moulding.

The invention will be explained below on the basis of an exemplary embodiment which is illustrated in the drawings, in which:

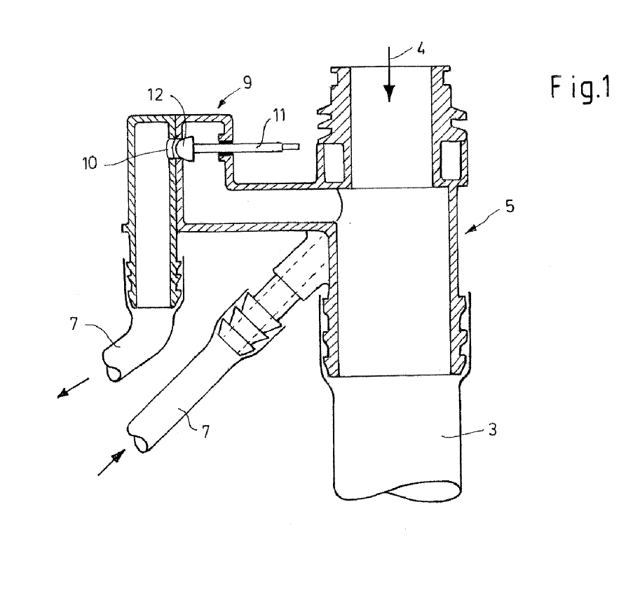

FIG. 1 shows a first variant of the reducing agent tank according to the invention, with only parts of the reducing agent tank being illustrated,

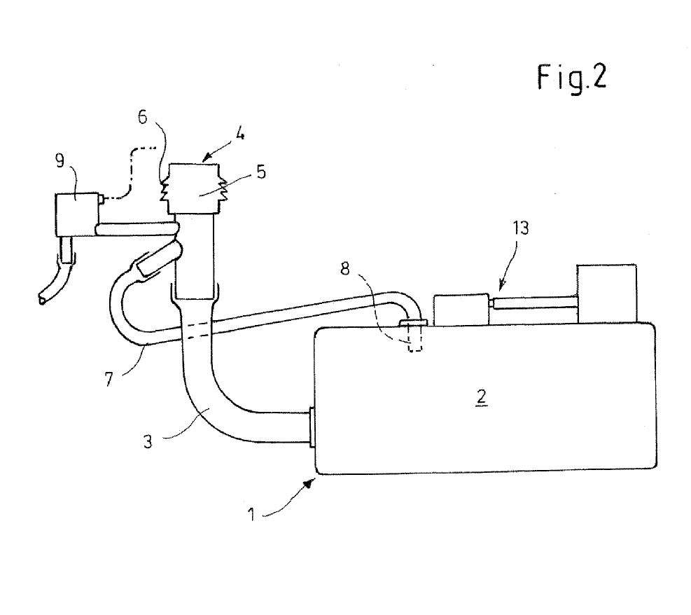

FIG. 2 shows a second exemplary embodiment of the reducing agent tank according to the invention, with the tank being illustrated in highly simplified form,

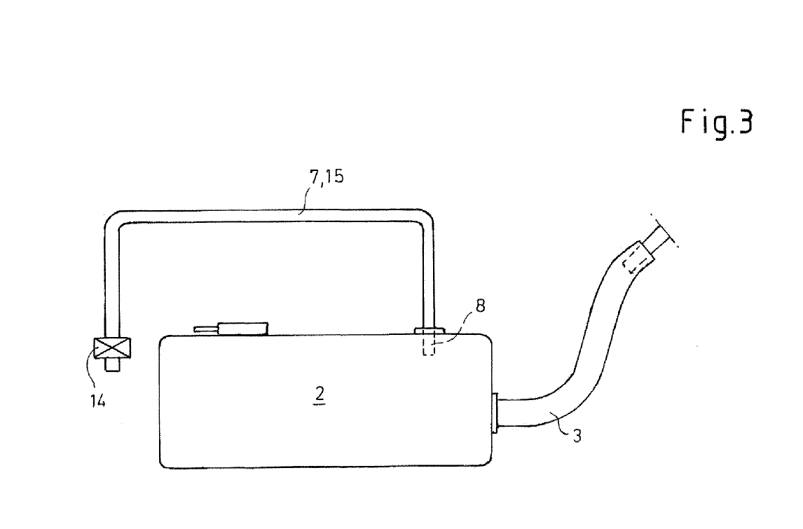

FIG. 3 shows the reducing agent tank according to a third exemplary embodiment of the invention,

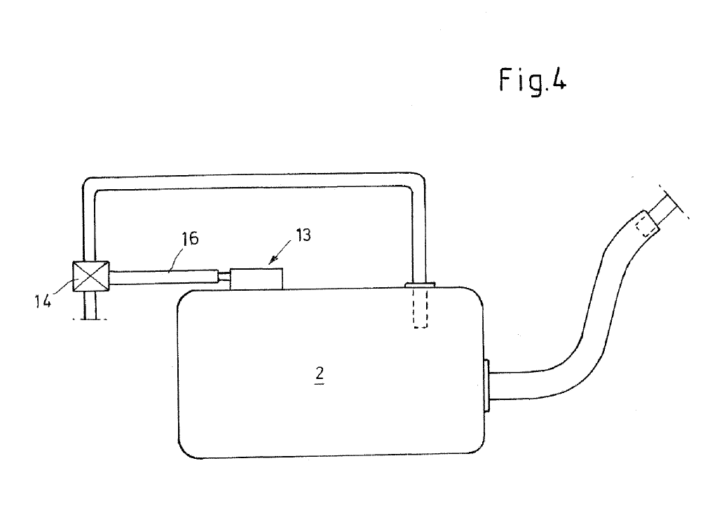

FIG. 4 shows the reducing agent tank of the invention according to a fourth exemplary embodiment,

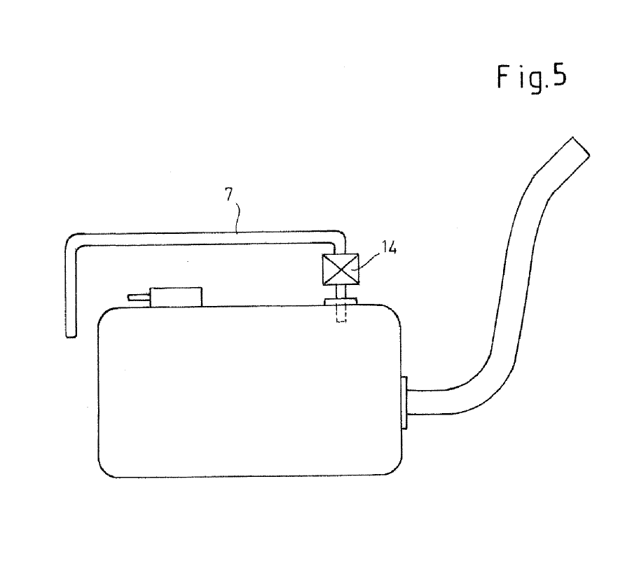

FIG. 5 shows a fifth exemplary embodiment of the reducing agent tank according to the invention,

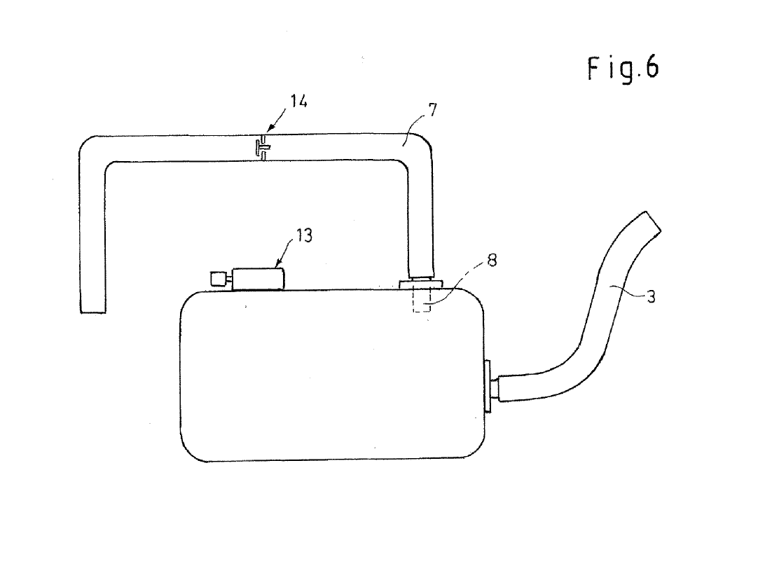

FIG. 6 shows a sixth exemplary embodiment of the reducing agent tank according to the invention,

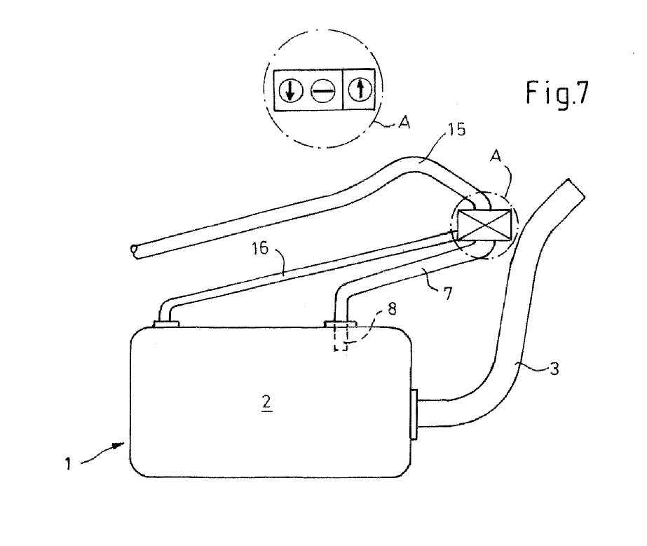

FIG. 7 shows a seventh exemplary embodiment of the reducing agent tank according to the invention,

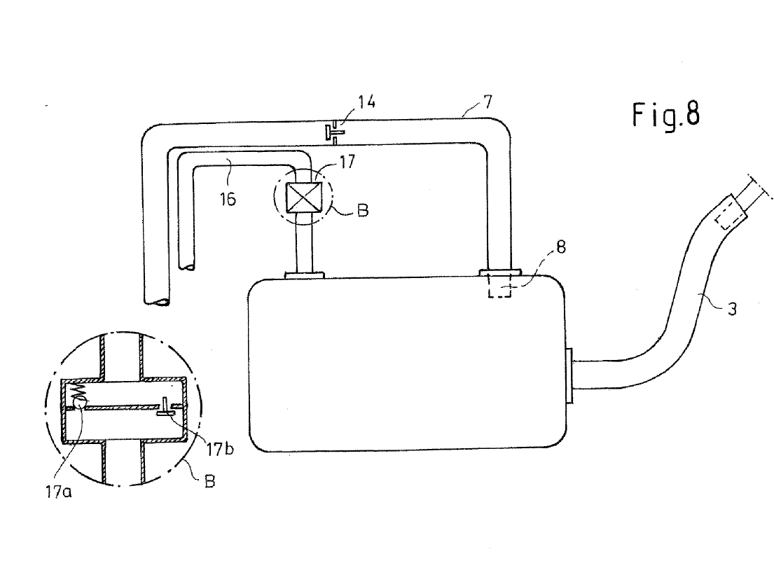

FIG. 8 shows an eighth exemplary embodiment of the reducing agent tank according to the invention,

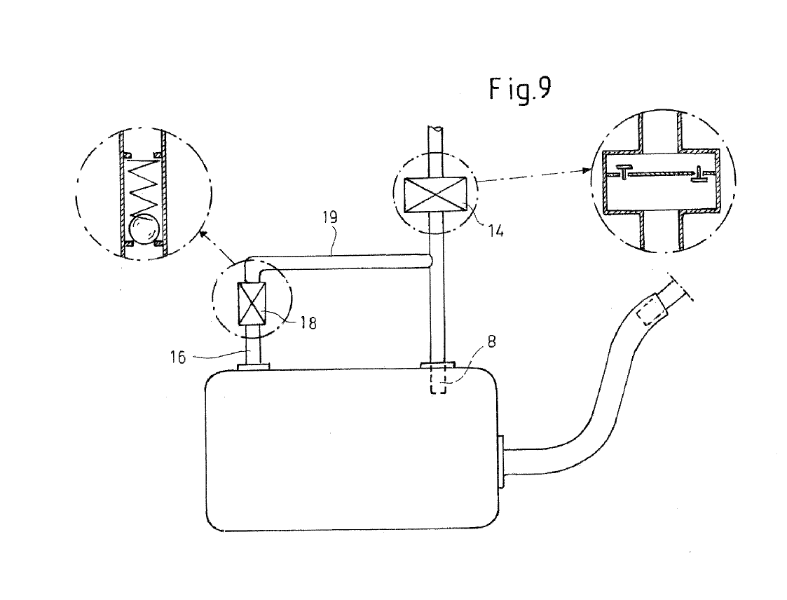

FIG. 9 shows the reducing agent tank according to a ninth exemplary embodiment of the invention, and

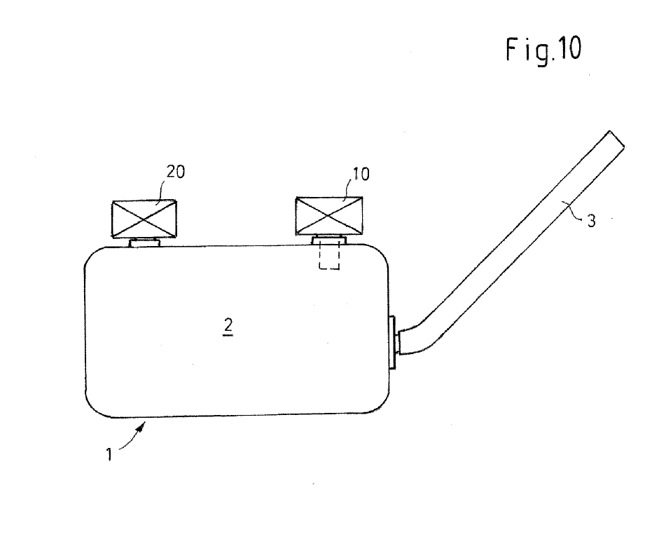

FIG. 10 shows a further variant of a reducing agent tank.

Reference is made firstly to FIG. 2 which shows a complete reducing agent tank 1 according to the invention in a schematic illustration. The reducing agent tank 1 according to the invention comprises the actual fill volume 2, which is enclosed on all sides, and a filler pipe 3 which is connected to said fill volume 2 and which has a filler opening 4 which is provided on a filler head 5. The filler head 5 is illustrated in FIG. 1 on an enlarged scale and partially in section. However, the exemplary embodiments according to FIGS. 1 and 2 differ as described below.

The reducing agent tank according to the invention is expediently formed as an extrusion blow-moulded plastic tank and serves to hold a liquid reducing agent in the form of an aqueous urea solution which is supplied to, or injected into, the exhaust gas of a diesel vehicle upstream of a so-called SCR catalytic converter.

The figures show the reducing agent 1 basically in the installation position.

As can be seen from FIG. 2, the filler pipe 3 is connected to the reducing agent tank 1 approximately in the lower region of the said reducing agent tank 1 when the latter is in the installation position. Such a variant is also referred to as sub-surface filling.

The filler head 5 is provided with a threaded collar 6 onto which a closure cap (not illustrated) can be screwed. The filler head 5 is designed as a line branch for a filling deaeration line 7 which is connected to the reducing agent tank 1 at the upper side of the latter. The filler opening 4 is dimensioned such that filling can take place via a nozzle device or a container, wherein a spout or a pipe stub of the nozzle device or of a container projects into the filler head 5 to such an extent as to open out into the filler head 5 below the connection of the filling deaeration line 7. In this way, it is ensured that the deaeration path formed by the filling deaeration line 7 is completely separated from the filling path formed by the filler pipe 3.

The filling deaeration line 7 is provided, at its end projecting into the fill volume 2, with an immersion pipe 8 which defines the height of the liquid level within the fill volume 2 and therefore the maximum fill height of the reducing agent tank 1.

The filling deaeration line 7 extends from the upper end of the fill volume 2 to the filler head 5 and from there to a switching valve 9. By means of the switching valve 9, the filling deaeration line 7 and therefore the deaeration path can be closed off after the filling process has ended.

Reference is now made to FIG. 1 which illustrates the filler head 5 and the switching valve 9 arranged thereon on an enlarged scale. FIG. 1 shows a first variant of the switching valve 9, in which the switching valve 9 can be actuated by means of a closure cap (not illustrated) for the filler pipe 3. The switching valve 9 comprises a valve opening 10 which can be closed off by means of a valve body 12 provided on the end of a plunger 11. The valve opening 10 is situated within the deaeration path defined by the filling deaeration line 7, with said valve opening 10 being situated above the maximum possible liquid level within the filler pipe 3 or the filler head 5. In this way, it is ensured at any rate that no liquid urea passes into the region of the switching valve 9. Downstream of the switching valve 9 in the flow direction, the filling deaeration line 7 communicates with the atmosphere.

FIG. 1 illustrates the valve body 12 in the open position, that is to say in which the valve opening 10 is opened up. The valve body 12 may for example be held in the open position in spring-loaded fashion.

If a closure cap is screwed onto the threaded collar 6 of the filler head 5, said closure cap can for example mechanically actuate the valve plunger 11 and press the valve body 12 into the valve opening 10, which forms a valve seat, such that the deaeration path is closed off.

In the variant of the reducing agent tank 1 shown in FIG. 2, the switching valve 9 is actuated by means of a Bowden cable (illustrated merely by way of indication). The design principle of the reducing agent tank according to the second exemplary embodiment in FIG. 2 otherwise corresponds to that of the first exemplary embodiment.

In FIG. 2, 13 denotes a pressure compensating element as a withdrawal aeration device and/or as an operational aeration device. The pressure compensating element 13 ensures, by means of valves or the like, an aeration of the reducing agent tank when reducing agent is withdrawn. If no reducing agent is withdrawn, aeration or deaeration takes place depending on the pressure gradient with respect to the environment. A withdrawal line is not illustrated in order to simplify the drawing.

During the filling of the reducing agent tank 1 through the filler opening 4 of the filler pipe 3, firstly the liquid level in the filler volume 2 will rise, wherein the gas volume provided within the reducing agent tank is discharged to the atmosphere via the filling deaeration line 7 via the filler head 5 and switching valve 9. The atmosphere connection of the filling deaeration line 7 is expediently so far remote from the filler opening 4 that the person filling the reducing agent tank 1 is not subjected to an odour nuisance.

The deaeration of the reducing agent tank 1 is possible until the liquid level closes off the immersion pipe 8 of the filling deaeration line 7. A further filling therefore causes the liquid column within the filler pipe 3 to rise. When replenishment is carried out by means of a nozzle, the rising liquid column would close off a breather bore of a nozzle and stop the replenishment process. When replenishment is carried out by means of a container, for example by means of the so-called ‘Kruse bottle’, the rising liquid would close off the neck of the container such that the latter would no longer be aerated and further liquid can no longer flow out. Over-replenishment of the reducing agent tank 1 according to the invention is therefore difficult. After the end of the replenishment process or filling process, the filler opening 4 would be closed off and the switching valve 9 actuated such that drying-out of the reducing agent tank 1 is reliably prevented. By means of the pressure compensating element 13, an aeration of the reducing agent tank 1 can be ensured for as long as reducing agent is withdrawn. This is possible either by means of mushroom valves, spring-loaded valve bodies or the like. In the variant of the reducing agent tank 1 illustrated in FIG. 2, too, the switching valve 9 and that part of the filling deaeration line 7 which extends from the filler head 5 are arranged above the maximum possible fill level in the filler pipe 3.

At this juncture, it is pointed out that, in all the exemplary embodiments, the same components are denoted by the same reference signs where possible.

In the variant of the reducing agent tank according to the invention illustrated in FIG. 3, the filling deaeration line 7 is connected openly to the fill volume 2. A valve 14 is provided at the atmosphere-side end of the filling deaeration line 7. The filling deaeration line 7 comprises an upper line section 15 which extends above the maximum fill level in the filler pipe 3. In comparison with the exemplary embodiment described above, this variant of the reducing agent tank 1 has the advantage of a smaller installation space requirement in the tank cover region. Furthermore, the routing of a line to the filler head 5 is dispensed with.

The variant of the reducing agent tank 1 according to the invention illustrated in FIG. 4 differs from the variant shown in FIG. 3 in that the valve 14 is designed as a 3-way valve and that an aeration line 16 of the pressure compensating element 13 is connected thereto. In this way, a toggle switch between the operating state of the reducing agent tank (withdrawal) and the filling deaeration state is realized in a simple manner.

The variant of the reducing agent tank 1 according to the invention illustrated in FIG. 5 corresponds in principle to the variant of the reducing agent tank 1 illustrated in FIG. 3, with the valve 14 being situated in the region of the fill volume 2 but at a sufficient distance from the fill volume 2.

In the variant of the reducing agent tank according to the invention illustrated in FIG. 6, a spring-loaded valve 14 is provided in the filling deaeration line 7, which valve 14 is designed for example as a so-called mushroom valve which is held in the closed position on account of its elasticity and which opens only in the event of a corresponding pressure rise in the fill volume 2. In this variant, it is necessary for the pressure compensating element 13 to be equipped with a pressure-maintaining valve such that the reducing agent tank 1 is not unpressurized. After the deactivation or ending of the filling process by means of the immersion pipe 8 of the filling deaeration line 7, the liquid column still present in the filler pipe 3 exerts a pressure in the interior of the reducing agent tank. The pressure-maintaining function of the pressure-compensating element 13 serves here to prevent over-replenishment.

Said variant of the reducing agent tank 1 is particularly cheap because no switching valve is required and it provides greater freedom for routing the filling deaeration line.

In an exemplary embodiment of the invention according to FIG. 7, a valve 14 is provided in the filling deaeration line 7, which valve 14 is designed as a 3-way valve to which the aeration line 16 is also connected. The valve 14 has two switching positions which are schematically depicted in FIG. 7 (enlarged detail A), with the left-hand part of the illustration symbolizing the operational deaeration and the right-hand part of the illustration symbolizing the filling deaeration. As in the first exemplary embodiment of the invention, the valve 14 may be arranged in the spatial vicinity of a filler head 5 such that for example reciprocal switching mechanically by means of a closure cap is possible. The valve may for example comprise, as valve bodies, two mushroom valves which act counter to one another. During the filling of the reducing agent tank 1, the path of the filling deaeration line 7 is opened up to the atmosphere, whereas the aeration line 16 is closed off. During operation, the path via the filling deaeration line 7 to the atmosphere can be closed off, whereas the path from the atmosphere via the aeration line 16 into the fill volume 2 can be opened. In this case, the valve 14 must be equipped with a pressure-maintaining function in order to prevent the fill volume 2 from drying out. In this variant of the reducing agent tank 1 according to the invention, too, a line section 15 of the filling deaeration line 7 is arranged above the maximum fill level in the filler pipe 3.

In the variant of the reducing agent tank 1 according to the invention illustrated in FIG. 8, a valve 14 is provided in the filling deaeration line 7 and a valve 17 is also provided in the aeration line 16. A schematic view of the valve 17 of the aeration line 16 is illustrated on an enlarged scale in view B. The valve 17 comprises a first valve body 17a and a second valve body 17b, with the first valve body 17a being designed as a spring-loaded ball and the second valve body 17b being designed as a mushroom valve. The first valve body 17a serves to realize a pressure-maintaining function for the reducing agent tank 1 and the second valve body 17b enables the fill volume to be aerated as reducing agent is withdrawn.

A further variant of the reducing agent tank 1 according to the invention is finally illustrated in FIG. 9. In said reducing agent tank 1, a valve 14 as a double mushroom valve is arranged in the filling deaeration line 7 above the fording line of the motor vehicle, which valve 14 enables both deaeration and also aeration of the reducing agent tank 1. A valve 18 with pressure-maintaining function is provided, as a spring-loaded ball valve, in the aeration line denoted by 16. The horizontally extending line section 19 of the aeration line 16 extends above the maximum fill level within the filler pipe 3.

In the variant of the reducing agent tank 1 illustrated in FIG. 10, the filling deaeration and operational deaeration are realized in each case by means of a diaphragm 20.

### LIST OF REFERENCE SYMBOLS

1 Reducing agent tank
2 Fill volume
3 Filler pipe
4 Filler opening
5 Filler head
6 Threaded collar
7 Filling deaeration line
8 Immersion pipe
9 Switching valve
10 Valve opening
11 Valve plunger
12 Valve body
13 Pressure compensating element
14 Valve
15 Line section
16 Aeration line
17 Valve
17a First valve body
17b Second valve body
18 Valve
19 Line section

1. Reducing agent tank for motor vehicles, having at least one filler pipe which is provided with a filler opening, having at least one device for filling deaeration and having means for limiting the fill level during filling, with the device for filling deaeration comprising at least one filling deaeration line which extends at least in sections above the maximum fill level in the filler pipe and/or in the tank.

2. Reducing agent tank according to claim 1, characterized in that the filling deaeration line forms a deaeration path which is at least substantially separate from the filling duct formed by the filler pipe.

3. Reducing agent tank according to claim 1, characterized in that the filling deaeration line can be closed off in a fill-level-actuated manner.

4. Reducing agent tank according to claim 1, characterized in that the filling deaeration line is guided with a projection, which is formed as an immersion pipe, in the region of the maximum fill level in the interior of the tank, such that when the maximum admissible fill level is reached, said filling deaeration line is closed off by the liquid level.

5. Reducing agent tank according to claim 1, characterized in that said reducing agent tank has no movable fittings.

6. Reducing agent tank according to claim 1, characterized by at least one valve which closes off the filling deaeration line with respect to the atmosphere and which is arranged at a distance from the tank connection of the filling deaeration line.

7. Reducing agent tank according to claim 6, characterized in that the valve is held in spring-loaded fashion in the position in which the filling deaeration line is closed off.

8. Reducing agent tank according to claim 6, characterized in that the valve can be actuated mechanically.

9. Reducing agent tank according to claim 8, characterized in that the valve can be actuated by means of a closure cover of the filler pipe.

10. Reducing agent tank according to claim 7, characterized in that the valve can be actuated by means of a Bowden cable.

11. Reducing agent tank according to claim 5, characterized in that the valve is designed as a switching valve which, in the position in which the filling deaeration line is closed off, opens up a withdrawal aeration and/or operational deaeration line.
